(19) United States
(12) Patent Application Publication
(10) Pub. No.: US 2022/0312762 A1
(43) Pub. Date: Oct. 6, 2022

(54) USE OF ENCAPSULATED STEROLS TO MODIFY GROWTH OF CROPS, CONTROL, AGRICULTURAL PESTS AND AS NON-TOXIC PRE-EMERGENT HERBICIDES

(71) Applicant: The Texas A&M University System, College Station, TX (US)

(72) Inventors: Lawrence Griffing, Hearne, TX (US); Krishna Kumar, College Station, TX (US)

(21) Appl. No.: 17/640,128

(22) PCT Filed: Sep. 6, 2020
(86) PCT No.: PCT/US20/49608

§ 371 Date: Mar. 3, 2022

Related U.S. Application Data
(60) Provisional application No. 62/896,992, filed on Sep. 6, 2019.

(51) Int. Cl. A01N 25/28; A01N 45/00

(52) U.S. Cl. CPC A01N 25/28; A01N 45/00

(57) ABSTRACT

In an embodiment, the present disclosure pertains to a method of inhibiting seed germination or modifying seedling growth. Generally, the method includes encapsulating or solubilizing sterols in an encapsulating agent and exposing a plant to the encapsulated or solubilized sterol in either a liquid or powdered-water-soluble form. In an additional embodiment, the present disclosure pertains to a composition that includes a sterol in an encapsulating agent in either a liquid or powdered-water-soluble form.

### CROSS-REFERENCE TO RELATED APPLICATIONS

This patent application claims priority from, and incorporates by reference the entire disclosure of, U.S. Provisional Patent Application No. 62/896,992 filed on Sep. 6, 2019.

### TECHNICAL FIELD

The present disclosure relates generally to encapsulated sterols and more particularly, but not by way of limitation, to compositions and methods for use of encapsulated sterols to modify growth of crops, control agricultural pests and as non-toxic pre-emergent herbicides.

### BACKGROUND

This section provides background information to facilitate a better understanding of the various aspects of the disclosure. It should be understood that the statements in this section of this document are to be read in this light, and not as admissions of prior art.

A mechanism by which sterols influence plant growth and development is through the activity of an end-product of the sterol pathway, the brassinosteroids (BRs). BRs act as hormone signals that, when absent, or their receptor is defective, produce extreme dwarfism and interfere with etiolation, producing phenotypes in the dark that show constitutive photomorphogenesis. BR abundance is regulated through negative feedback inhibition on the transcription of enzymes in its biosynthetic pathway. Mutants, such as, for example, dwf1, dwf5, or dwf7, in the pathway giving rise to campesterol (the precursor to BRs), produce dwarfing that can be chemically complemented by the addition of BRs to the medium.

However, there is also evidence that sterols produced at earlier stages in the BR pathway, or in pathways not leading to BRs, are important in plant growth and development. There are embryo-lethal (non-germinating) mutations, such as fackel/hydra1 or hydra2, and non-lethal mutations such as smt1 or smt2/3, in the sterol biosynthetic pathway of Arabidopsis that produce different relative concentrations of the main sterols, cholesterol, β-sitosterol, and stigmasterol. These mutations produce dwarfing, but cannot be chemically complemented by BRs. One effect of these mutations is to change the sterol profile, which can in turn change plant growth and development. However, these mutants could not be rescued with individual sterols, such as stigmasterol and β-sitosterol. However, these results need to be revisited as indicated by successful chemical complementation of hydra1 with β-sitosterol, detailed herein below, using a method by which sterols become internalized in plant cells.

A change in the sterol profile can also arise from treatment of plants with inhibitors of sterol biosynthetic enzymes. Lovastatin, an inhibitor of β-hydroxy β-methylglutaryl-CoA (HMG-CoA) reductase, one of the first enzymes in sterol biosynthesis, not only changes the sterol profile of plants, but also shuts down the isoprenoid pathway and cytokinin production. Chemical inhibitors, such as 15-aza-steroid of the enzyme 18,14-sterol-Δ14-reductase coded by the FACKEL gene, phenocopy the fackel mutation. The phenotype is also copied by the drug, fenpropimorph, which inhibits cyclopropyl sterol isomerase, an enzyme two steps earlier in the pathway. In the present disclosure, addition of the end-products of these pathways, except for BRs, through the disclosed delivery methods do not change the phenotype of inhibitor-treated seedlings, indicating that pharmacological treatments may have off-target effects, but that additional non-BR end-products work through the same pathway. BRs do have additional phenotypic effects, indicating that they work through a separate pathway.

Without being bound by theory, the hypothesis that individual sterols may act as plant growth regulators, separate from the effects of BR, is supported by several observations. β-Sitosterol is implicated in cell plate formation and polarized growth. Stigmasterol is involved in the regulation of HMG-CoA reductase (the enzyme inhibited by lovastatin), and when at elevated levels, can induce the expression of proteins involved in cell morphogenesis. Overexpression of the enzymes for cholesterol increases the endogenous free cholesterol in Arabidopsis and produces dwarfed plants. One molecular mechanism of the action of sterols, their influence on cellulose synthase activity, may be involved, but does not explain different effects on different organs.

The sterol profile of plants changes during development in different tissues. For example, in peas, embryos contain primarily β-sitosterol, with small amounts of cholesterol and stigmasterol, while in mature plants, that ratio is diminished, with stigmasterol and cholesterol increasing. The differential effect of added cholesterol on the growth of plants pre-germination vs. post-germination is discussed in terms of the varying concentrations of sterols with growth and the changing activities and abundance of RNAs coding for the intermediate enzymes in sterol biosynthesis.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method of inhibiting seed germination or modifying seedling growth. Generally, the method includes encapsulating or solubilizing sterols in an encapsulating agent and exposing a plant to the encapsulated or solubilized sterol in either a liquid or powdered-water-soluble form. In some embodiments, the sterol can include, without limitation, β-sitosterol, stigmasterol, campesterol, plant sterols and their synthetic or biological derivatives, and combinations thereof. In some embodiments, the encapsulating agent can include, without limitation, β-cyclodextrin, a sterol binding cyclic oligosaccharide, its derivatives and forms such as β-cyclodextrin, methyl-β-cyclodextrin and hydroxypropyl-β-cyclodextrin, sterol-binding peptides, α-, β-, or γ-cyclodextrins, α-, β-, or γ-cyclodextrins derivatives, and combinations thereof. In some embodiments, the sterols are solubilized in methyl-β-cyclodextrin, α-, β-, or γ-cyclodextrin, or α-, β-, or γ-cyclodextrin derivatives at a molar ratio that is equal to, or exceeds that of, the sterol in either liquid or powdered-water-soluble (encapsulated by liquid solubilization followed by drying) form. In some embodiments, the sterols are encapsulated or solubilized in a molar ratio of 1:1 or greater sterol binding cyclic oligosaccharide or peptide to sterol in either liquid or powdered-water-soluble form. In some embodiments, exposing the plant to the encapsulated or solubilized sterol reduces plant growth and development. In some embodiments, exposing the plant to the encapsulated or solubilized sterol reduces at least one of height of the plant, plant growth, and plant development. In some embodiments, exposing the plant to the encapsulated or solubilized sterol inhibits germination and/or post-germination growth (radicle enlargement) of dicotyledonous or monocotyledonous embryos and seeds. In some embodiments, exposing the plant to the encapsulated or solubilized sterol inhibits germination, radicle growth, and seedling growth of dicotyledonous or monocotyledonous plants. In some embodiments, the encapsulated or solubilized sterol is sequestered by the plant. In some embodiments, the encapsulated or solubilized sterol is transported to the root of the plant via the phloem.

In an additional embodiment, the present disclosure pertains to a composition including a sterol in an encapsulating agent in either liquid or powdered form. In some embodiments, the sterol can include, without limitation, β-sitosterol, cholesterol, stigmasterol, campesterol, plant sterols and their synthetic or biological derivatives, and combinations thereof. In some embodiments, the encapsulating agent can include, without limitation, cyclodextrins, a sterol binding cyclic oligosaccharide, sterol binding peptides, and combinations thereof. In some embodiments, the sterols are solubilized in methyl-β-cyclodextrin, α-, β-, or γ-cyclodextrin, α-, , β-, or γ-cyclodextrin derivatives, in either liquid or powdered-water-soluble form, at a molar ratio that is equal to, or exceeds that of, the sterol. In some embodiments, the sterols are encapsulated or solubilized in a molar ratio of 1:1 sterol binding peptide to sterol. In some embodiments, the sterol in the encapsulating agent is a non-toxic pre-emergent herbicide. In some embodiments, the sterol in the encapsulating agent is used to increase stalk strength in cereals or other crops subject to lodging. In some embodiments, the sterol in the encapsulating agent is used to change the allocation of photosynthate to seed/fruit production in maturing crops. In some embodiments, the sterol in the encapsulating agent is used to control predation upon plants by phloem-feeding insects. In some embodiments, the phloem-feeding insects are aphids, stink bugs, leafhoppers, scale insects, white flies, and combinations thereof. In some embodiments, the sterol in the encapsulating agent inhibits seed germination or modifies seedling growth.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1A shows 4,4-difluoro-4-bora-3a,4a-diaza-s-indacene (BODIPY)-cholesterol (BCh) uptake in the nuclear envelope with SUN2-RFP elongated root cell over a time period.

FIG. 1B shows dehydroergosterol (DHE) uptake curve in the nuclear envelope with SINE2-GFP over a time period.

FIG. 2 shows a sterol trafficking pathway illustration in Arabidopsis thaliana.

FIG. 3A shows data tracking the root growth for 5-days of plants grown on stigmasterol media and cholesterol media at day 2 and day 3 (days indicate days after planting).

FIG. 3B shows analysis of root hair growth of plants grown on cholesterol.

FIG. 3C shows analysis of root hair density of plants grown on cholesterol.

FIG. 3D shows analysis of root hair growth of plants grown on stigmasterol.

FIG. 3E shows analysis of root hair density of plants grown on stigmasterol.

FIG. 4A shows the ratio of yellowness with greenness of the cotyledons of 5-days old plants grown on the cholesterol media.

FIG. 4B shows chlorophylls concentration of 7-days old plants grown on cholesterol.

FIG. 4C shows the ratio of yellowness with greenness of the cotyledons of 5-days old plants grown on the stigmasterol media.

FIG. 4D shows chlorophylls concentration of 8-days old plants grown on stigmasterol.

FIG. 5A shows biomass quantification of 8-days old seedlings grown on cholesterol-supplemented media.

FIG. 5B shows biomass quantification of 8-days old seedlings grown on stigmasterol-supplemented media.

FIG. 6A shows the dose response of germination of Arabidopsis thaliana after one week.

FIG. 6B shows the effect of 300 microMolar β-sitosterol on the percent germination of Nicotiana tabacum (tobacco), Poa annua (annual bluegrass), Amaranthus palmeri (pigweed) and Zea mays (corn) grown in defined media.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Studies using mutants and chemical inhibitors of sterol biosynthesis in plants indicate that sterols other than the brassinolides impact normal growth and development. The present disclosure tests the hypotheses that it is possible to change the cellular concentration of different sterols and the ratios between them by the addition of the exogenous sterols, β-sitosterol, cholesterol and stigmasterol, and changing these sterol profiles will phenocopy mutants in the sterol biosynthetic pathway and plants treated with chemical inhibitors of sterol biosynthesis. Analysis of free and esterified sterols after the addition of increasing the external concentration of cholesterol and stigmasterol through several orders of magnitude revealed surprising results. First, instead of increasing the sterol content of plants, exogenous 100 μM cholesterol caused a decrease in total free sterols, and in particular, cholesterol and β-sitosterol. Second, that decrease correlated with a 40% decrease germination and severe dwarfism, which phenocopies mutations in sterol biosynthetic pathways. However, if plants were treated with 100 μM stigmasterol, total free sterols stayed about the same, but stigmasterol and β-sitosterol levels increased, while levels of cholesterol decreased. This was also accompanied by a 35% decrease in germination and severe dwarfism. At higher concentrations (100 uM) exogenous sterols applied during germination, the plants show altered chlorophyll metabolism, greening, changes in vasculature, and reduced growth of both roots and root hairs. The effects on root growth were similar to those found with chemical inhibitors of the sterol biosynthetic pathway. However, when the exogenous sterol was supplied after germination, root growth was normal. Based on the aforementioned, it is predicted that supplied cholesterol and stigmasterol act by negative feedback inhibition on cholesterol biosynthesis and uptake, but only when applied prior to, and during, germination and during the process of radicle enlargement and emergence from the seed coat.

Discussed in further detail below, it has been discovered that 100 uM concentrations of common plant sterols can completely inhibit seed germination and modify seedling growth, for example, when applied with an encapsulating agent. The data described herein indicates that the added sterol inhibits germination, and furthermore, provides for pre-emergent herbicides. For example, at higher concentrations, added sterols can completely inhibit germination.

Additionally, the results discussed below, indicate that added sterols can be utilized as growth regulators. For instance, added sterols can be used to control growth of plants. In some instances, the added sterols would only be added after the plant had germinated (for example, for 1 to 2 weeks). The sterols can include, without limitation, β-sitosterol, cholesterol, stigmasterol, campesterol, other plant sterols and their synthetic or biological derivatives, and combinations thereof.

Reference will now be made to more specific embodiments of the present disclosure and data that provides support for such embodiments. However, it should be noted that the disclosure below is for illustrative purposes only and is not intended to limit the scope of the claimed subject matter in any way.

### Effect of Exogenous β-Sitosterol, Cholesterol and Stigmasterol on the Growth and Development of Arabidopsis thaliana and Seedling Emergence in Common Weeds (Amaranthus palmeri, Poa annua, and Ambrosia sp.)

Plants and Plant Growth Conditions. Cholesterol (C3045, Sigma-Aldrich, USA), stigmasterol (S2424, Sigma-Aldrich, USA), and β-sitosterol (567152, Millipore-Sigma, USA) were prepared as stock solutions with a slight modification from that described in literature. Sterols were dissolved in 100% ethanol at 1.5 mM concentration and combined with methyl-β-cyclodextrin (MβCD) (Sigma-Aldrich, USA) at a molar ratio of 1:3 to a final concentration of 1-300 μM sterol and 1-900 μM MβCD. The probe was either sonicated for 30 minutes and vortexed for 15 minutes before use, or just vortexed for 30 min before use. To make a powered water soluble form, the sterol (40-70% w/w β-sitosterol) is dissolved in 100% ethanol and then solubilized in β-cyclodextrins or their derivatives in water. The solution is then reduced by evaporation or freeze-drying to a powdered form.

The wild-type and transgenic seeds of Arabidopsis thaliana were surface-sterilized with 70% ethanol, rinsed in sterile distilled water (+/− sterol) and incubated at 4° C. in the dark for 48 hr. The imbibed seeds were then planted either planted in Petri dishes or in hydroponic containers. For Petri dish growth, 1% (w/v) agar (Sigma-Aldrich, USA) was dissolved in ½ strength Murashige and Skoog medium containing vitamins (Caisson Labs, USA) (+/− sterol), and the pH was adjusted to between 5.6 and 5.8. The seedlings were grown in vertically placed Petri dishes containing this medium for 5-10 days at 22° C. under the continuous white light (50 μmol m⁻²sec⁻¹ photosynthetically active radiation). Hydroponic culture was a modification of that described in previous literature. The seeds were placed on a mesh inserted into the bottom of a sterile polypropylene 2 oz cup with a lid (TY-M2-100, Bingwu, sold on Amazon) inset into either a 4 oz sterile polypropylene cup (TY-M4-N50 Bingwu, sold on Amazon) or a black 5.5 oz sterile polypropylene Dart Conex cup (B07BK1DPPS, Table Top King, sold on Amazon). Enough medium (½ strength Murashige and Skoog medium containing vitamins (Caisson Labs, USA) (+/− sterol), and the pH was adjusted to between 5.6 and 5.8) was added to bring it up to the level of the mesh. They were grown for 5 days to maturity (˜75 days) in an 18:6 hr photoperiod at 22° C. with 100 μmole cm⁻²sec⁻¹ photosynthetically active. Following growth, they were then harvested for sterol analysis, leaf venation analysis, or fresh and dry weight analysis, or photographed for image analysis of root, hypocotyl, and stem growth and color. Seed from typical crop plants, Nicotiana tabacum (tobacco) and Zea mays (corn) were also sown in defined medium in the presence and absence of encapsulated sterol to assess percent germination after one week. Common weed seeds (Amaranthus palmeri, Poa annua, and Ambrosia sp.) collected from natural sources were either grown in defined media (agar and Mirashige and Skoog medium) or planted in natural soils (sandy loam) in 2 inch inserts in plastic one foot square flats. They were treated with 100-500 microMolar phytosterol mix (40% β-sitosterol, 20% campesterol, 7% stigmasterol (SKU BSIT100, Bulk Supplements) with a 3:1 molar ratio of methyl-β-cyclodextrin in water. Growth was assessed in treated and untreated (only water) by seedling emergence in days after planting in a greenhouse with natural lighting.

Sterol Analysis. Plants were weighed (fresh weight) and lyophilized Sterols were initially extracted from lyophilized plants with the addition 5 ml of 100% methanol (MeOH) (pre-equilibrated to hexane), plus 5 ml 100% hexane (pre-equilibrated to 50% MeoH/water). Additionally, 10 μg of cholestane was added to each sample (this served as an internal standard). Next, each sample was shaken vigorously for several seconds, followed by incubation at room temperature for 24 hr in the dark. The hexane fraction (containing free and acylated sterols) was then separated from the MeOH/water fraction (containing the glycosylated sterols), and both fractions were evaporated to dryness using nitrogen. For each sample, the hexane fraction was processed further for quantification of either the free sterols or acylated sterols, while each MeOH/water fraction was processed further for quantification of glycosylated sterols.

For free sterol analysis, 50% of the hexane fraction was taken, conjugated, and analyzed by gas chromatography-mass spectroscopy (GC-MS). For acylated sterol analysis, the remaining 50% of the hexane fraction was re-suspended in 100 μl of clean hexane and 8 ml of 70% MeOH-water containing 5% KOH was added, and then incubated in a shaking water bath (225 rpm) at 55° C. for 2.5 hr. This replaces the lipid moiety at C3 with a free hydroxyl group. The MeOH-water fractions were re-suspended in 8 ml 100% methanol containing 10% HCl, and then incubated in a shaking water bath (225 rpm) at 55° C. for 2.5 hr, to remove the carbohydrate moiety present at C3; it was replaced with a free hydroxyl group. Subsequently, all fractions contained free sterols, which were extracted from the chemically treated samples with water-equilibrated hexane; the hexane layer was then washed to neutrality with hexane-equilibrated water. The recovery rate of the internal standard (cholestane) was 92±5%. The level of detection for GC-MS was tens of nanograms; detection at this low level was made possible using selected ion chromatogram software, and selected ion-monitoring software GC-MSD ChemStation (Agilent Technologies).

The sterols contained in the three fractions were converted to their respective trimethylsilyl ether (TMS) derivatives, to ensure the inertness of the free C3 hydroxyl, by overnight incubation with a 2:1 excess volume v/v of BSTFA+TMCS, 99:1 (Sylon BFT; Supelco Inc. Bellefonte, Pa., USA). All conjugated sterols were processed by GC-MS, using an Agilent 6850N GC coupled with a 5973 mass selective detector (Agilent Technologies, Inc., Santa Clara, Calif., USA). The GC-MS was equipped with a fused capillary EC-5 column (30 m; Alltech, Nicholasville, Ky., USA) with a 0.25 mm internal diameter and 0.25 μm film thickness. The running conditions were: inlet 280° C., transfer line 290° C., column 80° C. (1 min), ramp at 10° C. min⁻¹ to 240° C., 240 to 300° C., ramp of 5° C. min⁻¹, with helium (1.2 ml min⁻¹) as carrier gas. The Agilent 5973 mass selective detector maintained an ion source at 250° C. and quadrupole at 180° C. Sterols were identified and quantified by GC-MS using selected ion monitoring (SIM) protocols for each steroid identified. Authentic sterol standards were purchased commercially from Sigma Chemical (St. Louis, Mo., USA), and Steraloids Inc. (Newport, R.I., USA).

### The Sterol Trafficking Pathway in Arabidopsis thaliana

Sterol plays a role in the determination of the biophysical properties of cellular membranes. Studies using the fluorescent sterol-binding drug, filipin, to track sterol transport from the plasma membrane (PM) to internal organelles have been interpreted to suggest that sterol uptake in plants occurs by endocytosis via clathrin-coated vesicles. The present disclosure uses fluorescent sterols, dehydroergosterol (DHE) and 4,4-difluoro-4-bora-3a,4a-diaza-s-indacene (BODIPY)-cholesterol (BCh), to directly follow the transport of sterol from the PM into the cell. Movement of DHE was analyzed with multi-photon microscopy, whereas BCh transport was studied with conventional confocal microscopy. It was concluded that the internalization of sterol occurs by a non-endocytic mechanism, perhaps involving endoplasmic reticulum (ER)-to-PM membrane contact sites (MCS). Without being bound by theory, evidence supporting this conclusion comes from absence of colocalization of fluorescent sterols with endosomes labeled either with fusion protein markers or by internalization of FM4-64. Within 15 minutes, both BCh and DHE label the nuclear envelope, a subdomain of the ER not typically on the endocytic pathway. Nuclear envelope labeling is enhanced with plasmolysis, a condition that changes the nature of the ER-to-PM MCS. Furthermore, the PM more easily detaches from the wall during plasmolysis with the addition of BCh. Sites labeled over the long term are consistent with sites suspected to be involved in sterol transport in the endomembrane pathway, the ER exit sites (ERES), the plasmodesmata, and the tonoplast. Short-term (<1.5 hr) treatment with BODIPY-cholesterol finds it accumulating in ER-derived compartments, the nuclear envelope and ER bodies, organelles not typically on the endocytic pathway. Long-term treatment (12 to 18 hr) finds it colocalizing with the tonoplast and trans-vacuol strands in roots and hypocotyls. As such, the pathway described herein differs from vesicular endocytosis. These findings highlight the potential importance of the ER-mediated sterol transport in plants.

Materials and Methods. Treatment with 10 microMolar BODIPY-Cholesterol (Top-Fluor, Avanti Polar lipids) and 10 microMolar dehydroergosterol (Sigma-Aldrich) was prepared in 30 microMolar methyl-β-cyclodextrin (Sigma-Aldrich). FM4-64 (Life Science Technologies) was used at 6 microMolar of concentration. Seedlings were grown for the indicated period of time under 24 hr light, 22° C. in ½ strength Murashige and Skoog (Caisson's Lab) agar (1%) medium.

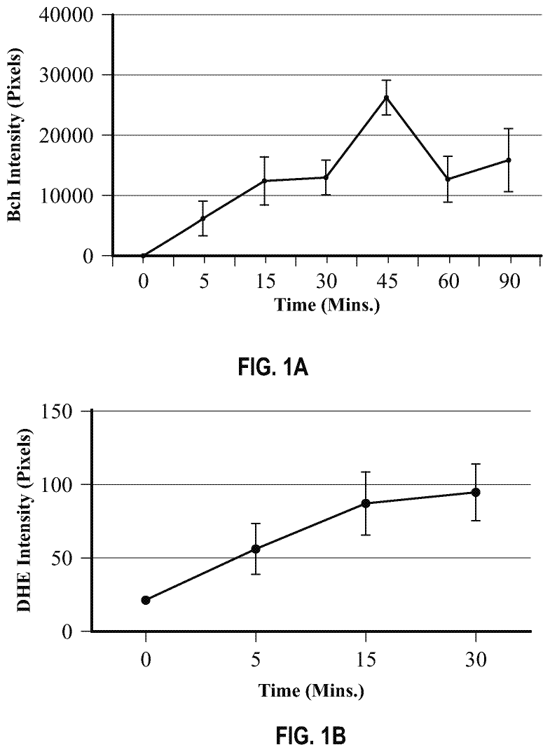

FIG. 1A shows Bch uptake in the nuclear envelope with SUN2-RFP elongated root cell over the time period. FIG. 1B shows DHE uptake curve in the nuclear envelope with SINE2-GFP over the time period.

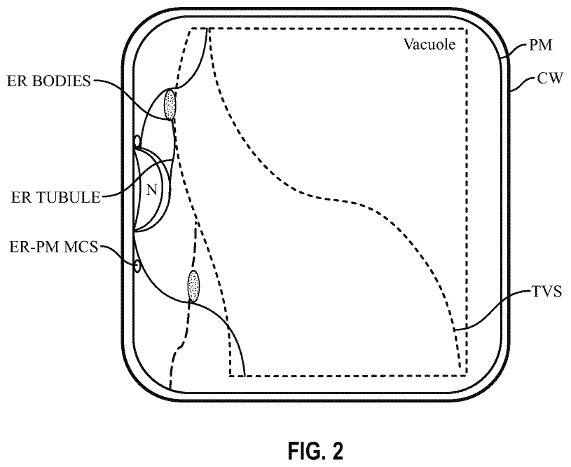

Results indicate that fluorescent sterols do not enter endocytotically, but move via a pathway that labels the nuclear envelope, then the vacuole (FIG. 2). Although fluorescent sterols label the plasma membrane (as does filipin), unlike filipin they do not enter by conventional endocytosis. Filipin is itself known to inhibit endocytosis and may be internalized, when used as a vital stain, in a way that is not typically taken by sterols. Therefore, its use as a vital stain is problematic. Fluorescent sterols also do not label the Golgi or the endosomes; however, it labels punctate structures on the PM. A possible pathway for the transport of sterol through ER-PM contact sites followed by transport in ER associated organelles has been shown. Short-term incubation with fluorescent sterol results in nuclear envelope labeling, followed by longer-term vacuole labeling movement in plants. Research has shown nucleus-vacuole junction (NVJ) association in yeast (which is regulated by Lam6) plant might have nuclear-vacuolar association also, which regulates the sterol transport. A possible pathway for the transport of sterol through ER-PM or NVJ has been shown.

### Effect of Exogenous Sterols (β-Sitosterol, Cholesterol and Stigmasterol) on the Growth and Development of Arabidopsis thaliana and Seedling Emergence in Common Weeds (Amaranthus palmeri, Poa annua, and Ambrosia sp.)

Sterol plays a role in the determination of the biophysical properties of membranes, but may also have other regulatory role in growth and development. Biochemical studies using mutants of sterol biosynthesis in Arabidopsis plants have been interpreted to suggest that sterols, other than the brassinolides, are important for cellular development and cell wall biogenesis. The present disclosure uses the exogenous sterols, cholesterol and stigmasterol, on Arabidopsis Col-0 lines to examine the effect of these sterols on plant growth and development. Dose-response curves of plant growth and development were obtained following growth for 3 to 5 days on sterol-supplemented media. The greatest response was achieved at 100 μM sterol. Growing of plants on media supplemented with 100 μM sterol causes shorter root and root hair growth, pale yellow cotyledon and an altered vascular pattern and root anatomy. There is also a delay in the germination of seeds growing on 100 μM sterols. When common weeds, Amaranthus palmeri (pigweed or careless weed), Poa annua (annual bluegrass) were grown in defined media for a week, there was more than 50% inhibition of seed germination compared with control. When common weeds, Amaranthus palmeri (pigweed or careless weed), Poa annua (annual bluegrass) and Ambrosia sp. (ragweed) were sown in natural soil and watered once with 200-500 microMolar solutions of mixed plant sterols (primarily β-sitosterol), emergence of seedlings was completely inhibited over the period of seven to seventeen days, while controls emerged within three days. These findings, and preliminary work on mutants on sterol biosynthetic pathways, indicate that imbalance in different sterols may lead to growth and developmental defects.

Materials and Methods. Arabidopsis seeds were given a pre-cold treatment with a mixture of sterol, cholesterol (Sigma-Aldrich) or stigmasterol (Sigma-Aldrich) (1 microMolar, 10 microMolar and 100 microMolar) and methyl-β-cyclodextrin (Sigma-Aldrich) (1:3 ratio) and then planted on Murashige and Skoog-½ strength (Caisson's Lab) 1% agar media supplemented with a mixture of respective sterol and cyclodexterin (1:3 ratio). Common weed seeds (Amaranthus palmeri, Poa annua, and Ambrosia sp.) collected from natural sources were planted in natural soils (sandy loam) in 2 inch inserts in plastic one foot square flats. They were treated with 100-500 microMolar phytosterol mix (40% β-sitosterol, 20% campesterol, 7% stigmasterol (SKU BSIT100, Bulk Supplements) with a 3:1 molar ratio of methyl-β-cyclodextrin in water. Growth was assessed by seedling emergence in days after planting in a greenhouse with natural lighting. Propidium iodide (Sigma-Aldrich) at 5 μM concentration was used to stain the cell wall. Table 1, shown below, illustrates composition of four major phytosterols in Arabidopsis.

TABLE 1
Content of major 4-demethylasterols in A. thaliana.

| | Amount (μg g⁻¹ fresh weight) | |
|---|---|---|
| | 1st Experiment | 2nd Experiment |
| Cholesterol | 6.60 | 7.94 |
| Cholestanol | 0.38 | 1.45 |
| Campesterol | 22.41 | 21.06 |
| Campestanol | 1.21 | 1.02 |
| Stigmasterol | 3.62 | 4.84 |
| Sitosterol | 107.13 | 99.45 |
| Sitostanol | 8.35 | 9.68 |

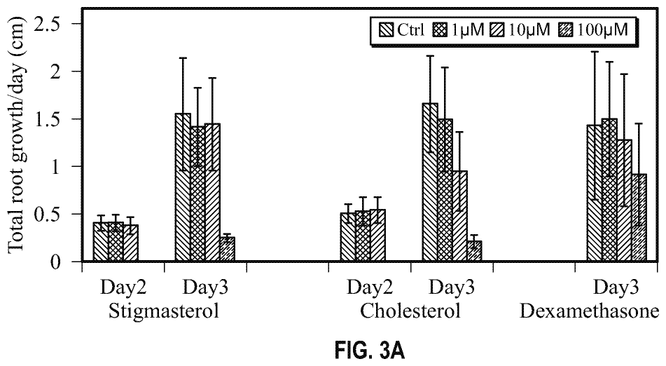

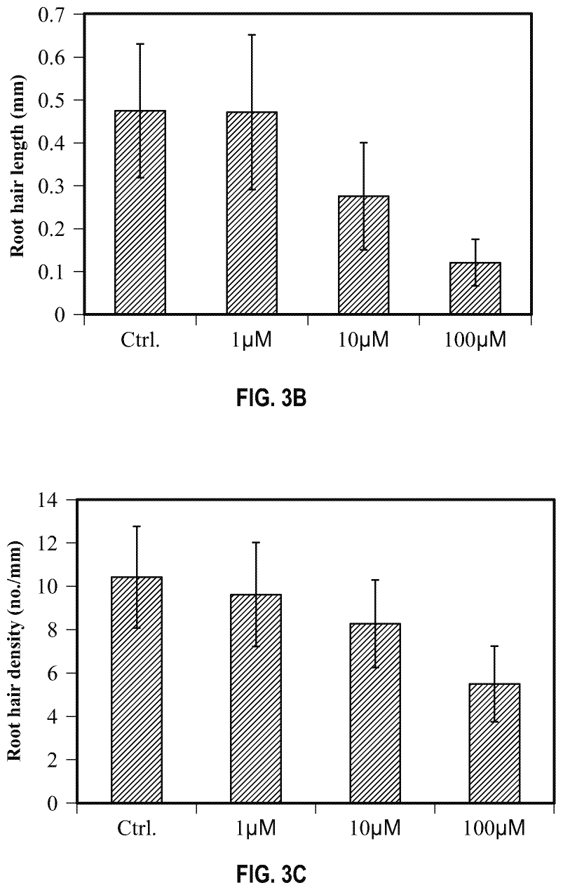

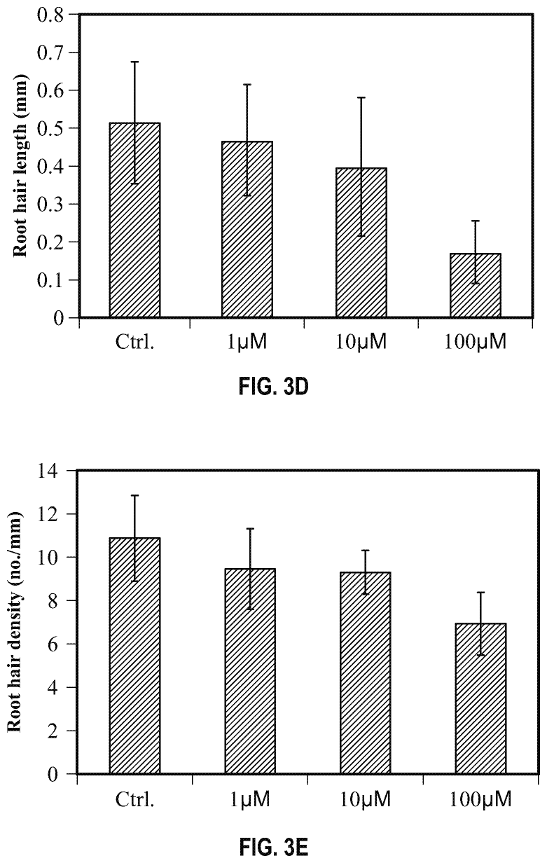

Results show that cholesterol and stigmasterol alters the plant root and root hair growth and development. FIG. 3A to FIG. 3E illustrate stigmasterol and cholesterol effects on root growth and development. FIG. 3A illustrates data tracking the root growth for 5-days of plants grown on stigmasterol media and cholesterol media at day 2 and day 3 (days indicate days after planting). Also shown in FIG. 3A is day 3 root growth data for plants grown on dexamethasone media. FIG. 3B shows analysis of root hair growth of plants grown on cholesterol. FIG. 3C shows analysis of root hair density of plants grown on cholesterol. FIG. 3D shows analysis of root hair growth of plants grown on stigmasterol. FIG. 3E shows analysis of root hair density of plants grown on stigmasterol.

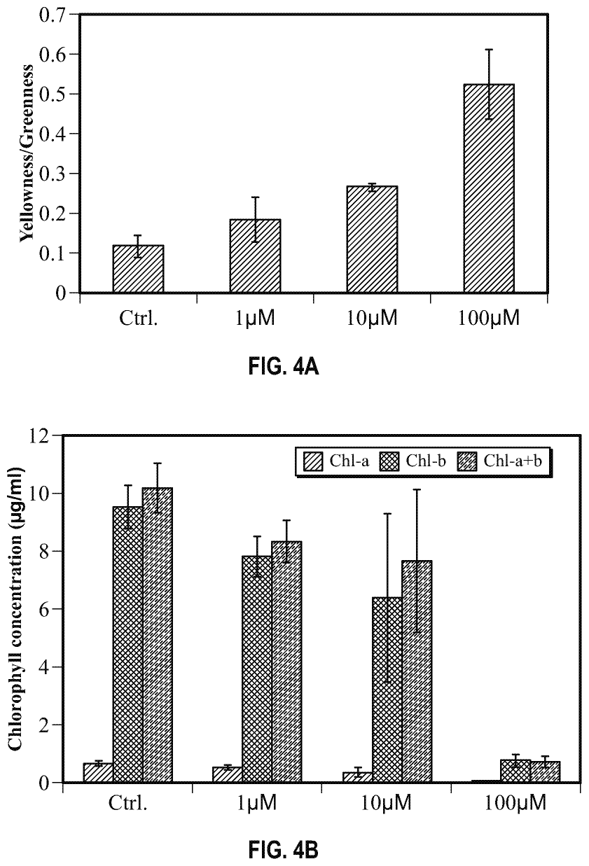

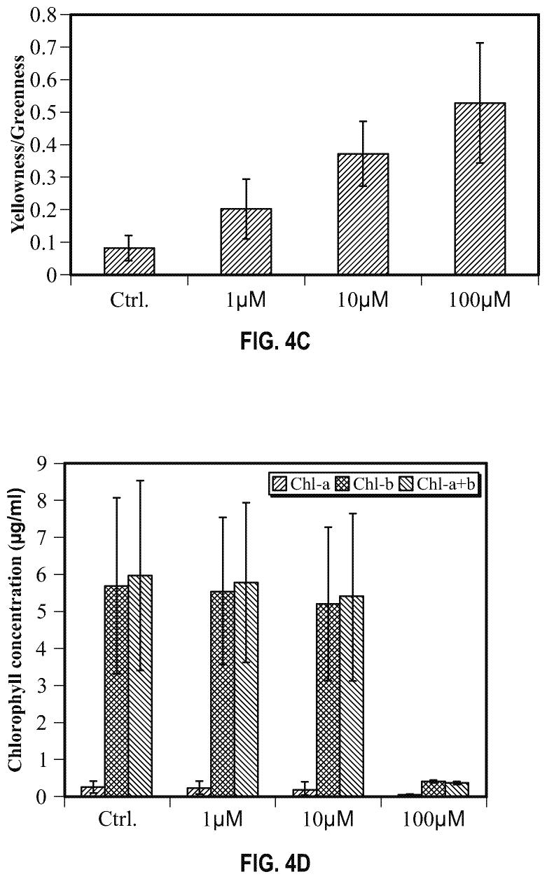

Furthermore, results indicated that cholesterol and stigmasterol change chlorophyll levels. FIG. 4A to FIG. 4D illustrate effects on the color, and the pigments of, the cotyledons or seed leaves. FIG. 4A shows the ratio of yellowness with greenness of the cotyledons of the 5-days old plants grown on the cholesterol media. FIG. 4B shows chlorophylls concentration of 7-days old plants grown on cholesterol. FIG. 4C shows the ratio of yellowness with greenness of the cotyledons of the 5-days old plants grown on the stigmasterol media. FIG. 4D shows chlorophylls concentration of 8-days old plants grown on stigmasterol.

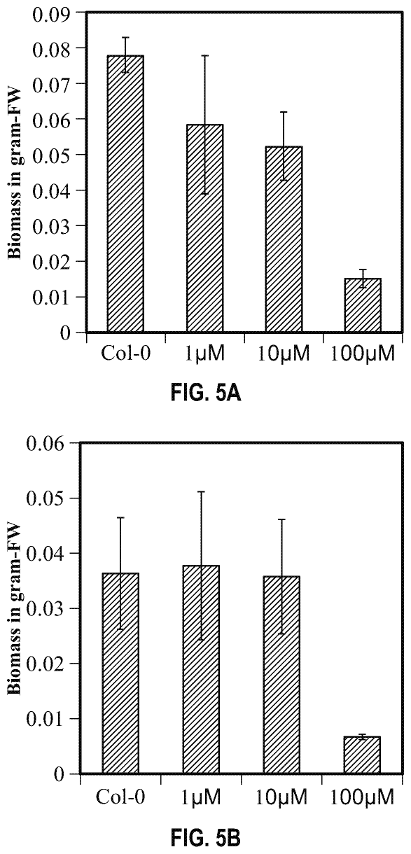

Additionally, results showed reduced biomass due to high cholesterol and stigmasterol. FIG. 5A to FIG. 5B illustrate biomass analysis of sterol supplemented grown plants. FIG. 5A shows biomass quantification of 8-days old seedlings grown on cholesterol-supplemented media. FIG. 5B shows biomass quantification of 8-days old seedlings grown on stigmasterol-supplemented media.

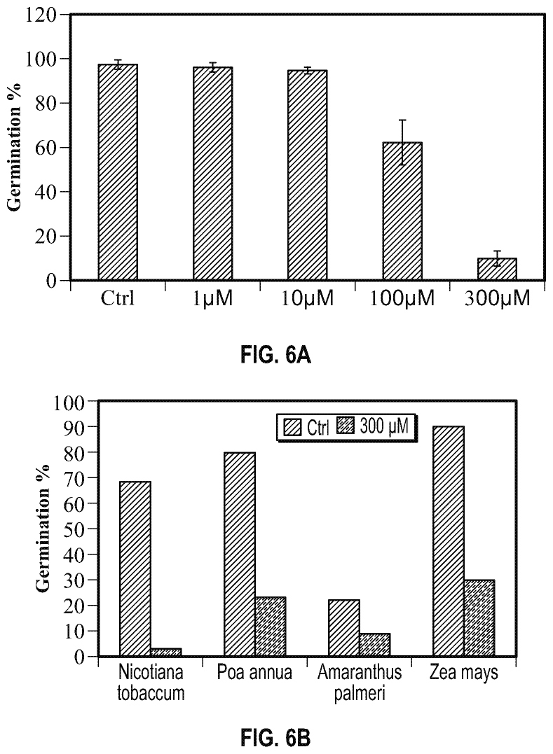

In addition, germination (as opposed to seedling growth) is effectively inhibited not only Arabidopsis but also in other dicots, tobacco and the common weed Amaranthus palmeri (pigweed) as well as in monocots Zea mays (corn) and the common weed Poa annua. FIG. 6A shows that germination of Arabidopsis thaliana seeds is inhibited by 90% after a week of growth at 300 microMolar encapsulated cholesterol. FIG. 6B shows that germination is greatly reduced in tobacco and pigweed after a week of germination on defined medium in 300 microMolar encapsulated sterol. FIG. 6B also shows that germination is reduced by more than 70% in the monocots Poa annua and Zea mays. Germination in these studies is separate from seedling growth and emergence. Seedling emergence was studied in natural soils in the greenhouse conditions.

In greenhouse studies on the effectiveness of methyl-β-cyclodextrin solubilized phytosterol mixes, several common weeds were tested. Effectiveness of the treatment was determined by the complete inhibition of seedling emergence in treated plants compared with the control. Amaranths palmeri (pigweed) seedling emergence was completely inhibited for 17 days (controls emerged by day 3). Annua poa (annual bluegrass) showed no emergence for seven days (controls emerged by day 2). Ambrosia sp. (ragweed) was completely inhibited for twelve days (controls emerged in 3 days). Once any emergence was detected in these species it was monitored and continued to show reduction compared with control even with no subsequent treatment of solubilized sterols. Periodic treatment of treated weed seeds subsequent to control emergence extended the inhibition period of emergence.

The imbalance in the sterol alters the growth and development. The results herein indicate that sterols, cholesterol, and stigmasterol contribute at the optimum level for the proper growth and development of Arabidopsis plant. However, studies have also shown that manipulation of genes in the sterol biosynthetic pathway, knocking them out/down or overexpressing them, creates an alteration in the profile of phytosterols resulting in reduced growth and development. The studies herein have shown a very similar phenotype with the exogenous application of 100 μM of cholesterol and stigmasterol. By doing so, this is not ruling out that the exogenously applied sterols will not disturb the genetic profile. By changing the free sterols ratio inside the cell in sterol, mutants have shown mislocalization of PIN protein, which regulates the auxin flux and maintains the cellular polarity. These results show the altered root anatomy at 100 μM of stigmasterol and cholesterol indicate altered cell polarity or expansion. The structural sterols are used for the initiation of root hairs; they accumulate at the growing root hairs tip. The diminished root hair growth at a higher concentration of the sterol, cholesterol or stigmasterol creates a low sitosterol profile like hydra2/fk or hyd1 mutant, which have defects in root/root hair growth. The cotyledon vascular patterning1 (CVP1), which encodes the C-24 sterol methyltransferase2 (SMT2) gene of sterol biosynthetic pathway and the mutant of CVP1 gene show alterations of sterol profiles creating an aberrant cotyledon vein pattern. The cvp1 mutant has a very high level of cholesterol. This study shows that increasing cholesterol (100 μM) causes altered vein pattern. Sterols profiling or sterol esters analysis, lipid body analysis, study of the effect of exogenous sterols in sterol mutants (hyd1, fk, cvp1, and smrs), and analysis of PIN distribution after exogenous sterol addition are further envisioned.

As shown above, it has been discovered that very low (microMolar) concentrations of common plant sterols can completely inhibit seed germination and modify seedling growth when applied with an encapsulating agent. The data above indicates that the added sterol inhibits germination, and furthermore, data presented herein provides for pre-emergent herbicides. For example, at higher concentrations, added sterols can completely inhibit germination. Additionally, the results discussed in detail herein, indicate that added sterols can be utilized as growth regulators. For instance, added sterols can be used to control growth of plants. In some instances, the added sterols would only be added after the plant had germinated (for example, for 1 to 2 weeks). The sterols can be, for example, cholesterol, stigmasterol, campesterol, and other plant sterols and their synthetic or biological derivatives. The encapsulating agent can be, for example, methyl-β-cyclodextrin, cyclodextrin, or a sterol binding peptide. As such, in some embodiments, the present disclosure relates to a method that involves encapsulating or solubilizing the sterols in cyclodextrin in a molar ratio of, for example, 3:1 cyclodextrin to sterol or a 1:1 molar ratio of sterol binding peptide to sterol.

At low concentrations (10 microMolar), the encapsulated sterols reduce plant height with minimal effects on fruiting and seed set. At higher concentrations (100 microMolar) the sterols inhibit the germination of dicotyledonous (weed) seeds. Encapsulated sterols are sequestered by the plant and transported to the root via the phloem. In some embodiments, the encapsulated sterols can be used as a non-toxic pre-emergent herbicide. Additionally, in some embodiments, the encapsulated sterols can also be used to increase stalk strength in cereals and change the allocation of photosynthate to seed/fruit production in maturing crops. Moreover, in some embodiments, the encapsulated sterols can also be used to control predation upon plants by phloem-feeding insects such as aphids.

Genetic engineering is used to make plants resistant to non-toxic herbicides. The present disclosure provides a general pre-emergent herbicide with common and often beneficial sterols for animal growth. The present disclosure also provides an alternative method to transgenic and toxic chemical approaches to modifying the height or other crop characters without influencing crop productivity. The present disclosure also provides for the production of transgenic crops which are resistant to the germination inhibition by overexpression of sterol transporters or enzymes in the sterol biosynthetic pathway. To control phloem-feeding insects, neonicotinoid pesticides are used.

The mammalian toxicity of these plant sterols is low and they are commonly used as herbal remedies in humans. Existing pre-emergent herbicides are toxic to livestock and humans. The sterols would be taken up by soil flora where they would be rapidly metabolized. By modifying plant growth, the plants will be more resistant to environmental stress (for example, they would not lodge as easily) and could be mechanically harvested more completely or easily. By modifying the spectrum of translocated sterols in the phloem in crop plants, phloem-feeding insects, which require cholesterol and other sterols for production of molting hormone and other important aspects of insect hormone metabolism, may no longer feed or may no longer be able to reproduce. Existing neonicotinoid pesticides have pollinators (for example, bees) as secondary targets, whilst these may not.

The present disclosure shows that in the absence of the encapsulating agent (for example, cyclodextrins or sterol binding peptides), the sterols are ineffective and do not enter the plant. The cellular pathway of internalization of the sterols when added with methyl-β-cyclodextrin has been shown. It has also been determined herein that when the encapsulated sterols are applied to leaves or the shoot, they are translocated via the phloem to the root, where they then control growth of the plant. When translocated through the phloem, the solubilized sterols are probably taken up specifically by phloem-feeding insects. The present disclosure further shows that at 100 microMolar concentration, encapsulated cholesterol and stigmasterol significantly inhibit seed germination of Arabidopsis, but at 10 microMolar concentration, seeds germinate. Plant stem growth is somewhat reduced at 10 microMolar concentration of encapsulated sterols. Encapsulated sterols could be manufactured as a post-emergent growth regulator on crops and/or as a pre-emergent herbicide and/or as a non-toxic pesticide.

Furthermore, overexpression of HMGS up-regulates HMGR, SMT2, DWF1, CYP710A1 and BR6OX2, leading to enhanced sterol content and stress tolerance in Arabidopsis. Additionally, SMT2 OE increases sitosterol and stigmasterol and reduced cholesterol and growth. CYP10A1 and CYP10A4 OE increases stigmasterol at the expense of sitosterol. Moreover, more squalene can relate to more free sterol.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

1. A method of inhibiting seed germination or modifying seedling growth, the method comprising:
encapsulating or solubilizing sterols in an encapsulating agent; and
exposing a plant to the encapsulated or solubilized sterol in either a liquid or powdered-water-soluble form.

2. The method of claim 1, wherein the sterol is selected from the group consisting of β-sitosterol, cholesterol, stigmasterol, campesterol, plant sterols and their synthetic or biological derivatives, and combinations thereof.

3. The method of claim 1, wherein the encapsulating agent is selected from the group consisting of α-, β-, or γ-cyclodextrins, α-, β-, or γ-cyclodextrins derivatives, and combinations thereof.

4. The method of claim 1, wherein the sterols are solubilized in α-, β-, or γ-cyclodextrin at a molar ratio that is equal to, or exceeds that of, the sterol.

5. The method of claim 1, wherein the sterols are encapsulated or solubilized in a molar ratio of 1:1 or greater sterol binding peptide to sterol.

6. The method of claim 1, wherein exposing the plant to the encapsulated or solubilized sterol reduces at least one of height of the plant, plant growth, and plant development.

7. The method of claim 1, wherein exposing the plant to the encapsulated or solubilized sterol inhibits germination, radicle growth, and seedling growth of dicotyledonous or monocotyledonous plants.

8. The method of claim 1, wherein the encapsulated or solubilized sterol is sequestered by the plant.

9. The method of claim 8, wherein the encapsulated or solubilized sterol is transported to the root of the plant via the phloem.

10. A composition comprising a sterol in an encapsulating agent in either liquid or powdered form.

11. The composition of claim 10, wherein the sterol is selected from the group consisting of β-sitosterol, cholesterol, stigmasterol, campesterol, plant sterols and their synthetic or biological derivatives, and combinations thereof.

12. The composition of claim 10, wherein the encapsulating agent is selected from the group consisting of cyclodextrins, a sterol binding cyclic oligosaccharide, sterol binding peptides, and combinations thereof.

13. The composition of claim 10, wherein the sterols are solubilized in methyl-β-cyclodextrin, α-, β-, or γ-cyclodextrin, α-, β-, or γ-cyclodextrin derivatives, in either liquid or powder form, at a molar ratio that is equal to, or exceeds that of, the sterol.

14. The composition of claim 10, wherein the sterols are encapsulated or solubilized in a molar ratio of 1:1 sterol binding peptide to sterol.

15. The composition of claim 10, wherein the sterol in the encapsulating agent is a non-toxic pre-emergent herbicide.

16. The composition of claim 10, wherein the sterol in the encapsulating agent is used to increase stalk strength in cereals or other crops subject to lodging.

17. The composition of claim 10, wherein the sterol in the encapsulating agent is used to change the allocation of photosynthate to seed/fruit production in maturing crops.

18. The composition of claim 10, wherein the sterol in the encapsulating agent is used to control predation upon plants by phloem-feeding insects.

19. The composition of claim 18, wherein the phloem-feeding insects are aphids, stink bugs, leafhoppers, scale insects, white flies, and combinations thereof.

20. The composition of claim 10, wherein the sterol in the encapsulating agent inhibits seed germination or modifies seedling growth.

21. The method of claim 1, further comprising at least one of increasing stalk strength or changing the allocation of photosynthate to seed/fruit production.

22. A composition comprising:
a sterol in an encapsulating agent in either liquid or powdered form; and
wherein the sterol in the encapsulating agent increases stalk strength in cereals or other crops subject to lodging, or changes the allocation of photosynthate to seed/fruit production in maturing crops.
